(19) United States
(12) Patent Application Publication
(10) Pub. No.: US 2015/0058222 A1
(43) Pub. Date: Feb. 26, 2015

(54) Unified Identity Management for Mobile Web Payments

(71) Applicant: FireID Payments (Proprietary) Limited, Stellenbosch (ZA)

(72) Inventors: Carl Henri Kritzinger, Somerset West (ZA); Marius Marais, Somerset West (ZA); Johannes Gerrit Greeff, Stellenbosch (ZA); Francois Malan Joubert, Somerset West (ZA)

(21) Appl. No.: 14/389,156

(22) PCT Filed: Apr. 2, 2013
(86) PCT No.: PCT/IB2013/052620

§ 371 Date: Sep. 29, 2014

(30) Foreign Application Priority Data
Mar. 30, 2012 (ZA) 2012/02333

(51) Int. Cl. G06Q 20/40

(52) U.S. Cl. CPC G06Q 20/40
USPC 705/44

(57) ABSTRACT

A method of facilitating a transaction is disclosed. The method includes generating a unique transaction identifier which is associated with a transaction to be per formed between a merchant and a user and which is embedded in a URL. The URL is displayed to a user wishing to perform a transaction via a mobile web browser. Using an application on the user's mobile device, the unique transaction identifier is extracted from the URL and transmitted to an information brokerage service. At the information brokerage service, transaction data is generated including payment information. The transaction data is transmitted to the user's mobile device or another computing device. The information brokerage service receives a transaction confirmation message from the user, and transmits payment details to a payment gateway or the merchant. A system for implementing the method is also disclosed.

### BACKGROUND OF THE INVENTION

THIS invention relates to a method and system for facilitating transactions via mobile websites.

The standard online shopping experience is mostly quite easy, but becomes very cumbersome at the “checkout” part of the process, where e-commerce sites frequently require a user to register an account with the site before the order process can be completed. This account registration frequently requires the selection of a new password to control access, as well as verification of the user's email address. Once the user has registered, payment details frequently have to be filled in manually, with only the biggest sites able to afford the infrastructure to store credit card details securely. Some sites also offer EFT payment and other options, but these methods all involve manual steps, requiring additional authentication to other external services.

The current state of mobile commerce has the same pitfalls, except that it is even more cumbersome to supply all the required information on such a small device.

It is an object of the invention to provide an alternative mechanism for facilitating online transactions via mobile phones and other mobile devices.

### SUMMARY OF THE INVENTION

According to the invention there is provided a method of facilitating a transaction, the method including:
generating a unique transaction identifier associated with a transaction to be performed between a merchant and a user;
embedding the unique transaction identifier in a URL;
displaying the URL to a user wishing to perform a transaction via a mobile web browser;
using an application on a user's mobile device, extracting the unique transaction identifier from the URL and transmitting the unique transaction identifier to an information brokerage service; and
at the information brokerage service, generating transaction data including payment information associated with the unique transaction identifier, and transmitting the transaction data to the user's mobile device or another computing device; receiving a confirmation message from the user; and transmitting payment details to a payment gateway or the merchant.

The mobile application is preferably installed on the user's mobile device prior to commencement of the transaction, but can also be installed during the transaction process.

The account information of the user is preferably part of a user profile created by the user and may include the user's name, address, contact information, and bank account, credit card or other payment details for use in transactions.

The user profile may be stored on the user's mobile device itself or by a secured service.

The unique transaction identifier is preferably generated by the information brokerage service in response to a request by a merchant offering a transaction to one or more users.

The payment details may include one or more of a credit card number, a billing address, a shipping address and an e-mail address.

Further according to the invention there is provided a system for facilitating transactions according to the method defined above, the system comprising an information brokerage service including data storage, the information brokerage service being operable to create and store user profiles, to generate a unique transaction identifier associated with a transaction to be performed between a merchant and a user, to receive data representative of a unique transaction identifier extracted from a URL by a user wishing to conduct a transaction with a merchant, to generate transaction data including payment information, to transmit the transaction data to the user's mobile device or another computing device, to receive a transaction confirmation message from the user, and to transmit payment details to a payment gateway or the merchant.

### BRIEF DESCRIPTION OF THE DRAWINGS

FIG. 1 is a simplified schematic diagram showing the operation of a system for facilitating a transaction according to the invention.

### DESCRIPTION OF PREFERRED EMBODIMENTS

The mobile phone has become a ubiquitous device that most people carry around every day. The invention leverages this phenomenon through the use of a specialized Mobile Payment and Identity Application (referred to below as the “mobile app”), installable on a mobile phone. It should be appreciated that the invention is not limited to mobile phones as such, but could be used with other mobile computing devices with the necessary functionality, such as tablets and the like.

This mobile app is tied to an Information Brokerage Service, which is authorized to transfer information about transactions from a user's accounts, either by use of a credit card, direct banking integration, various forms of virtual currency, vouchering systems or similar.

By generating a value in the form of a large random number and embedding the value in a specialized URL, it becomes possible to link values from a mobile website to a mobile app and vice versa.

For example, it is possible to click a link in a mobile web browser, which opens the correct mobile app on the user's phone.

By registering a transaction with the Information Brokerage Service, which returns a secure identifier which uniquely identifies the transaction, and using the returned secure identifier to build an application-specific URL, it becomes possible to transfer a secure transaction from the mobile web browser to the mobile app.

The mobile app extracts the secure identifier from the URL, requests the transaction details from the Information Brokerage Service over a standard secure communications channel as is provided by the mobile phone, and displays the information to the user on the mobile phone. The user is then provided with an option to complete the transaction or cancel.

At the time of registering a transaction, a merchant would supply all the information necessary to successfully complete the transaction, for example a full description of the products or services, the total price, the merchant's banking details, and other relevant information.

Once a user acts upon a transaction and accepts the transaction on his or her mobile phone, the mobile app securely instructs the merchant or payment gateway to proceed with the transaction. The mobile app may optionally require the user to enter a PIN or password before confirming the transaction to ensure that the only the user is in control of his or her mobile phone.

For example, in the case of a transaction requiring delivery of physical goods, the mobile application would forward the user's billing and shipping addresses to the merchant, whereas in the case of a digital download, the mobile application may inform the merchant of the user's e-mail address or other relevant information.

The operation of the method and system of the invention is summarised concisely below:
1. The User installs the Mobile Payments and Identity application on his or her phone or other mobile device.
2. The mobile app generates a user profile which is associated with the User's identity and payment details (for example, bank account or credit card details).
3. Later, the User browses a Merchant's mobile commerce website and selects items to purchase.
4. During the checkout process the User is presented with a new link or button indicating the mobile application as a mechanism for payment.
5. The Merchant requests a specialized URL from the Information Brokerage Service.
a. The Merchant supplies the Information Brokerage Service with the critical details of the payment, which includes the Merchant's details, the total amount required to effect the payment, a suitable breakdown of the pricing, etc.
b. Other relevant descriptive information is added, as well as a list of information required from the User for the payment to be completed, for example shipping and billing addresses for a physical delivery, etc.
c. The special “return URL” can be added to the request, which specifies a URL that the User should be redirected to once the payment has been completed (successful or not).
d. The Information Brokerage Service generates a specialized URL containing a unique identifier for the payment and returns it to the Merchant. For example, the URL may be of the form “fireidpayments://pay/xxxyyyzzz”.
e. The URL protocol (“fireidpayments://” above) specified by the URL is associated with the mobile app on the user's mobile phone.

6. Opening the URL causes the mobile app to launch automatically.
a. The mobile app extracts the unique identifier from the URL (“xxxyyyzzz” above) and retrieves the payment details from the Information Brokerage Service
b. Thus, the mobile app can display the exact details of the transaction to the User.

7. The application prompts the User whether he wishes to complete the transaction.

8. The User decides whether to accept or decline the transaction.
a. If the User accepts the transaction, the application confirms the transaction with the Information Brokerage Service.
b. The mobile app transmits the required profile information to the merchant or payment gateway.
c. This action associates the User's identity with the previously anonymous payment.

9. If specified, the mobile app returns the User to the website indicated in the “return URL” component of the transaction request.

10. The Merchant website is opened again, this time showing a page with the outcome of the transaction. The Merchant now has access to the User's identity, which allows it to create a profile of the User, without requiring a cumbersome signup process.

11. The Merchant continues with its standard purchasing process to complete the transaction, for example shipping items to the User.

### Example: Mobile Commerce

A user comes across an online shop on his or her mobile phone, which he/she has never used before. He or she browses the products available and selects a few, adding them to his or her virtual shopping cart. Having added all the required items, the user selects the shop's “checkout” option. On the checkout screen a button is displayed to enable payment with the mobile app.

(The online shop has registered the transaction with the Information Brokerage Service, indicating that it will require the user's physical address for delivery and e-mail address for delivery of a tax invoice. The Information Brokerage Service returns a secure identifier, embedded in a URL, for the transaction. The URL is converted to a button and displayed on the mobile website.)

The user clicks the “Pay with Mobile Payment app” button, which launches the mobile app on the user's mobile phone. The app shows the user the products he or she has selected, the total price and that the merchant will be advised of his or her physical and e-mail addresses, asking the user to confirm the transaction.

(The mobile app has extracted the identifier from the URL and retrieved the transaction details associated with the identifier and displayed them inside the mobile app.)

The user confirms the transaction and enters his or her PIN to confirm the user's identity. The user is automatically returned to the mobile website, which now shows that the payment has been accepted, shows the user where his or her goods will be delivered and e-mails the user a copy of his or her tax invoice. The user does not have to perform any further actions, but has the option to update his or her delivery address. The user closes his or her mobile web browser and receives the purchased goods the following day.

(The mobile app has instructed the Information Brokerage Service that the transaction is completed and transmitted the required profile details to the merchant. The merchant processes the payment, adds the order to its shipping queue with the correct delivery address and emails the user a copy of his/her tax invoice. The Mobile Payment app opens up the URL specified in the “return URL” part of the transaction registration request.)

The user receives an e-mail newsletter the following week with specials from the mobile commerce website, indicating items that might be useful to him or her based on the user's prior purchases.

(The Merchant has used the identity information supplied by the mobile application to construct a profile for the user, without having to ask the user for any additional information.)

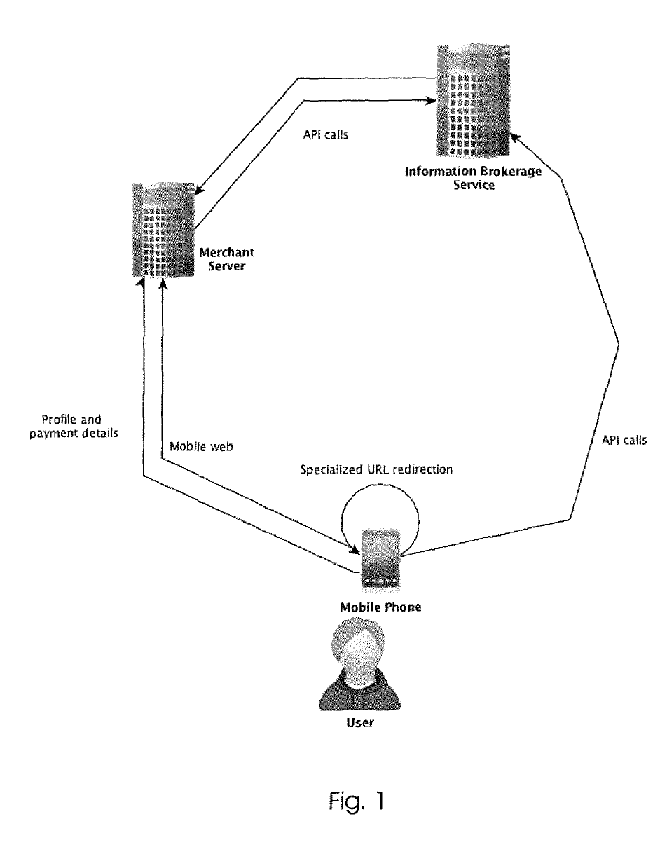

The above-described process is illustrated concisely in the schematic diagram of FIG. 1.

It can be noted that the Information Brokerage Service will typically be implemented by means of a server with an associated database, which can communicate with a merchant server and the user's mobile device using API (application programming interface) calls transmitted over a mobile telephone network or other data network.

1. A method of facilitating a transaction, the method including:
a. generating a unique transaction identifier associated with a transaction to be performed between a merchant and a user;
b. embedding the unique transaction identifier in a URL;
c. displaying the URL to a user wishing to perform a transaction via a mobile web browser;
d. using an application on a user's mobile device, extracting the unique transaction identifier from the URL and transmitting the unique transaction identifier to an information brokerage service; and
e. at the information brokerage service, generating transaction data including payment information associated with the unique transaction identifier, and transmitting the transaction data to the user's mobile device or another computing device; receiving a confirmation message from the user; and transmitting payment details to a payment gateway or the merchant.

2. A method according to claim 1 wherein the mobile application is installed on the user's mobile device prior to commencement of the transaction.

3. A method according to claim 1 wherein the mobile application is installed on the user's mobile device during the transaction process.

4. A method according to claim 1 wherein the account information of the user is part of a user profile created by the user, including one or more of the user's name, address, and contact information, and bank account, credit card or other payment details for use in transactions.

5. A method according to claim 1 wherein the user profile is stored on the user's mobile device.

6. A method according to claim 1 wherein the user profile is stored by a secured service.

7. A method according to claim 1 wherein the unique transaction identifier is preferably generated by the information brokerage service in response to a request by a merchant offering a transaction to one or more users.

8. A method according to claim 1 wherein the payment details include one or more of a credit card number, a billing address, a shipping address and an e-mail address.

9. A system for facilitating transactions, the system comprising an information brokerage service including data storage, the information brokerage service being operable to create and store user profiles, to generate a unique transaction identifier associated with a transaction to be performed between a merchant and a user, to receive data representative of a unique transaction identifier extracted from a URL by a user wishing to conduct a transaction with a merchant, to generate transaction data including payment information, to transmit the transaction data to the user's mobile device or another computing device, to receive a transaction confirmation message from the user, and to transmit payment details to a payment gateway or the merchant.
